(19) United States
(12) Patent Application Publication
(10) Pub. No.: US 2010/0028598 A1
(43) Pub. Date: Feb. 4, 2010

(54) Decorative rollable structure attachable to fences, walls, or other substrates

(76) Inventors: Kaveh Soofer, Tiburon, CA (US); Bret Baumgarten, San Rafael, CA (US)

Correspondence Address: KAVEN SOOFER, 16 Gilmartin Drive, Tiburon, CA, 94920, US

(21) Appl. No.: 12/221,402

(22) Filed: Aug. 4, 2008

(51) Int. Cl. B32B 3/24

(52) U.S. Cl. 428/138

(57) ABSTRACT

Proposed is a flexible decorative non-stand-alone structure that consists of a flexible matrix-like infrastructure, a plurality of decorative elements, such as artificial leaves or flowers, and a cord for connecting the decorative elements to the flexible matrix-like infrastructure by passing through the openings provided in the decorative elements and by being twisted around the cells of the matrix-like infrastructure. The decorative structure can be attached to rigid substrates such as walls or fences for closing the structural defects or damages of the substrates. or for obstructing the view therethrough from outsiders.

### FILED OF THE INVENTION

The present invention relates to decorative structures that can be attached to various substrates or supporting structures such as walls, fences, pillars, etc. More specifically, the invention concerns decorative structures of the aforementioned type which are flexible, preferably to the extent that they can be wound into rolls and consist of a flexible net or mesh and a plurality of decorative elements attachable to the aforementioned net and not creating obstacle for winding the structure into a roll.

### BACKGROUND OF THE INVENTION

Many existing structures are in a condition of disrepair, do not provide privacy, or have an unattractive appearance. Rectification of the aforementioned conditions such as repair or painting may be extremely expensive and time consuming. For example, if the structure is a large building the external wall of which require painting or repair, such a remedy may involve purchasing of expensive material, high labor cost, and long duration of time. Privacy and security can be compromised by provision of fences which allows outsiders to see in, e.g., in the case of chain-link fences or wooden fences with openings between the slats. Another way to remedy the conditions is to grow natural plants such as trees, climbing vines, hedges, etc. However, such measures require an extra space, proper growing conditions which may depend on the climate, as well as the time to reach maturity. Moreover, the naturally grown decorative and privacy protective object also require permanent maintenance and attention such as watering, pruning, or trimming. It is also important to mention that watering may damage the structures and surrounding areas.

Other situations such as construction zones with temporary fences may spoil appearance of the neighboring residential and commercial areas and therefore may require some decoration measures.

Attempts have been made heretofore to overcome the above drawback by creating the portable or semi-permanent, and in some case, permanent decorative structure such as fences, panels, or sheets.

U.S. Pat. No. 1,386,450 issued in 1921 to R. Tully describes an artificial hedge comprising a substrate made in the form of a green fabric having a plurality of loose ends protruding from the green fabric and imitating the foliage.

U.S. Pat. No. 3,647,605 issued in 1972 B. Spiegel, discloses an artificial tree or bush utilizing a three-dimensional shell or basket-like framework having the general shape of a tree or a bush. The foliage of the bush or tree is comprised of a plurality of artificial needles, leaves or flowered attached to the framework in an overlapped state in order to hide the supporting structure.

U.S. Pat. No. 4,872,647 issued in 1989 to F. Paradise et al. discloses an artificial hedge comprising a chain link fence having a plurality of interlocking wires twisted together at spaced intervals to form a plurality of diamond shaped openings arranged in parallel rows, and a plurality of camouflage assemblies supported on the fence. The camouflage assemblies comprising a central elongated axial support element and relatively stiff densely packed filament means fixedly carried by the support element and extending laterally of the axis thereof. The filament means form a bush-like planar array that extends along the entire length of the support element. At least one of the camouflage assemblies is inserted in a selected plurality of rows of openings in the fence such that the support element passes through the openings in the selected rows so that when a plurality of such elements is thus inserted the fence assumes a hedge-like appearance.

Spanish Patent ES1055794 issued in 2005 to R. Urbina describes an artificial hedge which is designed to enclose gardens and which comprises a plurality of interconnected parallel branches. The aforementioned branches are formed by wires which are twisted with strips of colored plastic material and which extend out radially from the core of the rods. The assembly is sufficiently dimensioned such as to form dense branch-like rolls which obstruct the view therethrough once the hedge has been installed.

European Patent Application EP1693537 published in 2006 (inventor T. Valentini) describes an artificial hedge that comprises, at least a substantially flat support element, on which artificial decorative elements are fixable for simulating a natural hedge. The support member of the artificial hedge comprises a rigid modular grid-shape structure provided with protrusions that extend in a direction substantially perpendicular to the plane of the support. The protrusions terminate at a free end thereof with a conical tip, at the base of which flaps are provided. To fix an artificial leaf to the support element, the eyelet of the appendage is inserted on a protrusion, positioning the eyelet below the flaps. The dimensions of the eyelet are selected in such a way that the flaps prevent the eyelet from accidentally coming out of the protrusion, for example due to a fortuitous impact on the leaf or because of the dynamic action of the wind.

A disadvantage of some of the conventional decorative structure described above is that they are not rollable and comprise rigid stand-alone structures such as decorative walls, fences, artificial trees, or bushes. Such devices are inconvenient in storage and transportation.

A disadvantage of other known devices, such as one described in U.S. Pat. No. 1,386,450 and comprising an artificial hedge having a substrate in the form of a green fabric having a plurality of protruding loose ends, is that, first of all, the green fabric with loose ends does not look like a real foliage at all, and, second of all, the fabric substrate is not weatherproof and is not suitable for outdoor application.

Regarding another flexible, structure described in Spanish Patent ES1055794, what is disclosed in this patent is not an integral structure consisting of the net-like structure with artificial foliage attached to the matrix cells of the net, but a plurality of strips attachable one by one to the existing stand-alone supports such as rigid fences. Attachment of a plurality of such strips composed of decorative bands twisted with wired to a fence or wall is an inconvenient and time-consuming operation.

### OBJECTS AND SUMMARY OF THE INVENTION

It is an object of the present invention to provide a flexible decorative non-stand-alone structure attachable to any substrate such as a wall, fence, etc. It is another object to provide the aforementioned structure that can be wound into a roll for convenience of storage, transportation, and application. It another object to provide the flexible structure of the aforementioned type which can obscure direct view from outsiders. It is another object to provide the aforementioned structure which has an attractive appearance imitating a live hedge, vine, flowers, or other foliage. A further object is to provide a flexible decorative non-stand-alone structure of the aforementioned type having a simple construction composed of a molded flexible matrix-type net or mesh and decorative members in the form of leaves, flowers, or the like, easily and reliably connectable to the molded flexible plastic matrix-type net or mesh. A still further object is the flexible decorative non-stand-alone structure of the aforementioned type wherein the decorative elements can be easily replaced entirely or selectively without replacing the matrix-like net or mesh. Another object is to provide the flexible decorative non-stand-alone structure that can be used indoors as well as outdoors around a year during different climatic seasons.

In a typical form, a flexible decorative non-stand-alone structure of the invention consists of three basic elements, i.e., a flexible matrix-like infrastructure, a plurality of decorative elements, and attachment members for connecting the decorative elements to the flexible matrix-like infrastructure. The aforementioned attachment members may comprise separate elements, can be made integrally with the decorative elements, or can be made integrally with the matrix-like infrastructure. The term “decorative non-stand-alone structure” means that the decorative structure of the invention cannot stand alone as a decorative fence, wall, or another rigid structure but rather has to be attached to a supporting substrate such as the aforementioned fences, walls, or boards. In a preferred embodiment, the flexible decorative non-stand-alone structure of the invention comprises a thin and strong matrix-like infrastructure extruded from a plastic material in the form of a net or mesh connected to which are garlands of artificial foliage. Each garland is comprised of artificial leaves, flowers, or both, having openings in leaves' petioles or flowers' pedicels for threading a thin flexible foliage-piercing member such as thread, cord, or thin wire through these openings. The aforementioned thread, cord, or thin wire is then passed through the neighboring cells of the matrix-like substrate with twisting around the frame elements of the cell for fixing the artificial foliage relative to the matrix-like infrastructure. In order to provide more reliable fixation of the decorative elements to the matrix-like infrastructure, the foliage piercing element can be twisted around the cell-frame element more than once.

The leaves, flowers, or other decorative elements can be arranged with density such that the artificial foliage obstruct the view therethrough once the decorative structure has been installed. The density, e.g., of leaves, can be increases by connecting several leave petioles to each other and forming a common opening in the place of their connection. The entire structure can be stored in a rolled form and unrolled directly at the place of installation for securing the structure to the rigid substrate such as fence, veranda, wall, etc.

### BRIEF DESCRIPTION OF THE DRAWINGS

FIG. 1 is a general view of the decorative rollable structure of the invention.

FIG. 2 is a view of a single decorative unit composed of three leaves.

FIG. 3 is a three-dimensional view illustrating the structure of the invention in a rolled form for storage and transportation.

FIG. 4 is an example of attachment of the decorative structure of the invention to a rigid support, e.g. a wall.

FIG. 5 shows an example of attachment of the flexible decorative structure 20 of the invention to a rigid stand-alone support or substrate

### DETAILED DESCRIPTION OF THE INVENTION

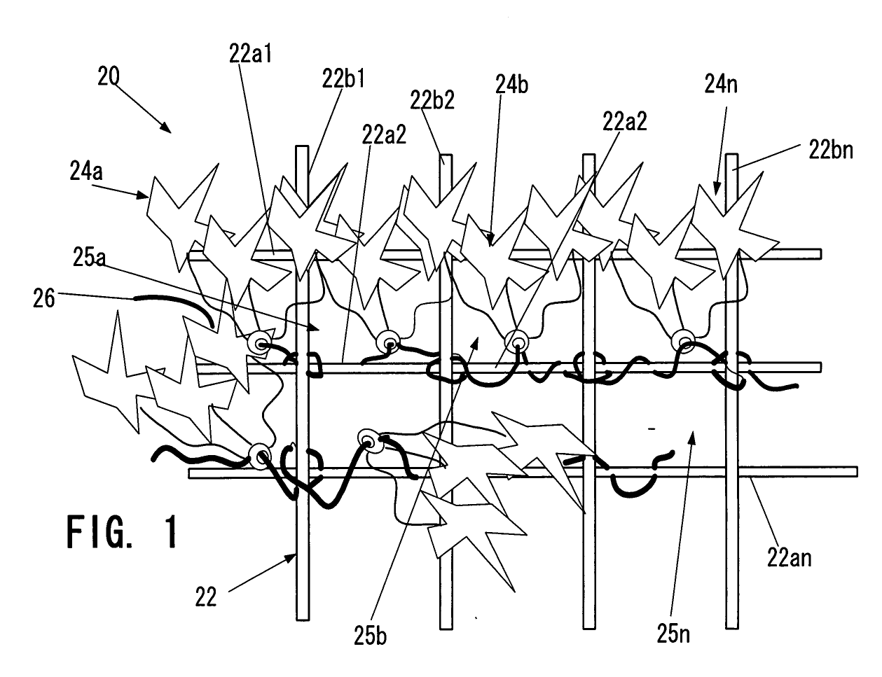

An example of a decorative rollable structure of the invention is shown in FIG. 1, which is a general view of the structure. In a typical form, a flexible decorative non-stand-alone structure 20 of the invention consists of three basic elements, i.e., a flexible matrix-like infrastructure 22, a plurality of decorative elements 24a, 24b, . . . 24n, and attachment elements, such as a cord 26 for connecting the decorative elements 24a, 24b, . . . 24n to the flexible matrix-like infrastructure 22.

The term “decorative non-stand-alone structure” means that the decorative structure 20 of the invention cannot stand alone as a decorative fence, wall, or another rigid structure but rather has to be attached to a supporting substrate such as the aforementioned fences, walls, or boards.

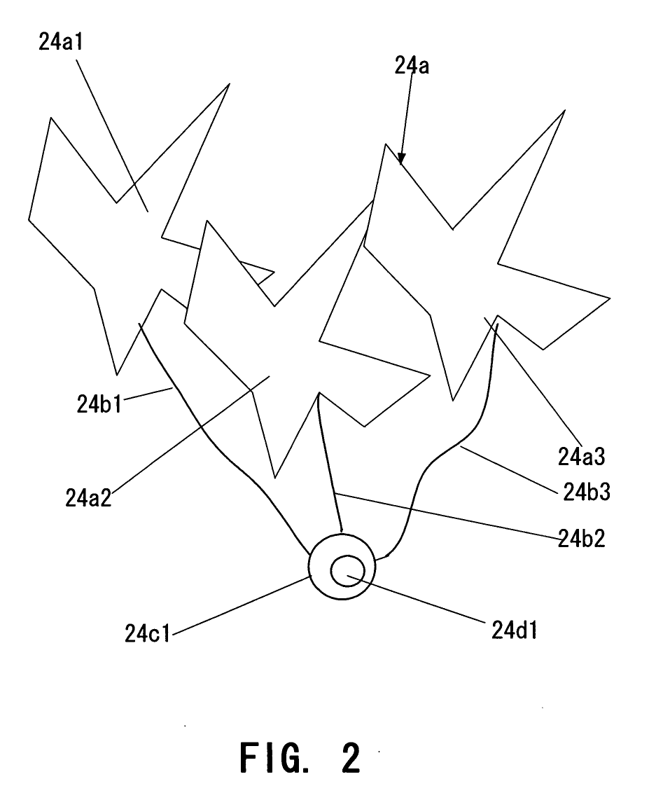

An example of a decorative element, e.g., the decorative element 24a, is shown in FIG. 2. In the illustrated embodiment, the decorative element 24a is a single unit comprised of three artificial leaves 24a1, 24a2, and 24a3, flexible petioles 24b1, 24b2, and 24b3 of which are interconnected at a common knot 24c1 having a through opening 24d1 for insertion of the cord 26.

The leaves 24a1, 24a2, and 24a3 and the flexible petioles 24b1, 24b2, and 24b3 can be molded as an integral unit from a plastic material, or the leaves can be stamped out from a rubberized water-proof fabric, and the flexible petioles 24b1, 24b2, and 24b3 can be extruded from a plastic material and attached by means of an adhesive.

The flexible matrix-like infrastructure 22 is shown in FIG. 1 as a net-like unit molded from plastic or composed of extruded rids interconnected by adhesive or thermal welding. In any case, the infrastructure 22 consists of mutually perpendicular rods such as rods 22a1, 22a2, . . . 22an and rods 22b1, 22b2 . . . 22bn, respectively. These rods form individual cells with through openings.

As can be seen in FIG. 1, the cord 26 that is threaded through the openings 24d1, 24d2, . . . 24n in the respective knots 24c1, 24c2, . . . 24n of the petioles 24b1, 24b2, and 24b3 is twisted at least once around the points of intersection 28a1, 28a2, . . . 28an of mutually intersecting rods 22a1, 22a2, . . . 22an and rods 22b1, 22b2, . . . 22bn, thus securing the decorative elements, i.e., the artificial leaves 24a1, 24a2, and 24a3 and their petioles 24b1, 24b2, and 24b3 to the matrix-like infrastructure 22.

For assembling the decorative structure, the each cord, such as the cord 26 can be threaded through the opening, such as the opening 24d1, twisted once or more times around the point of intersection of the rods 22a1 and 22b1, passed through the opening 24d2 in the second decorative element, twisted once or more times around the point of intersection of the rods 22a2 and 22b2, and so on.

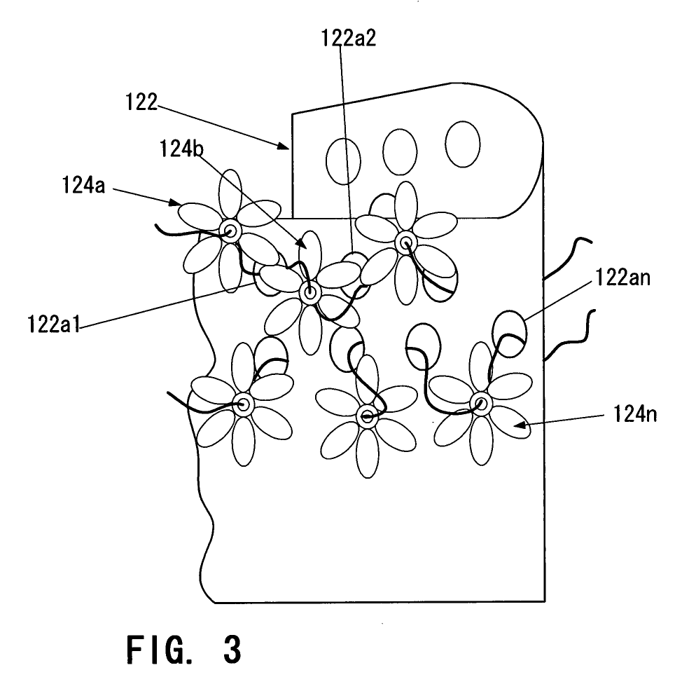

The flexible matrix-like infrastructure is not necessarily a net-like structure formed by wires or rods. As shown in FIG. 3, such a rollable infrastructure 122 may be formed by a perforated sheet of a plastic or any other rollable weather-proof material, wherein the cells are formed by openings 122a1, 122a2, . . . 122an. The decorative elements are shown as flowers 124a1, 124a2, . . . 124an.

It is understood that, if it is necessary to replace the damage decorative elements 24a, 24b, etc. or replace the entire garland or all the decorative elements, this can be easily done by untwisting the cords, such as the cord 26 from the frame formed by the matrix-like infrastructure, removing the decorative elements from the cord and repeating the above-described assembling procedure with new decorative elements.

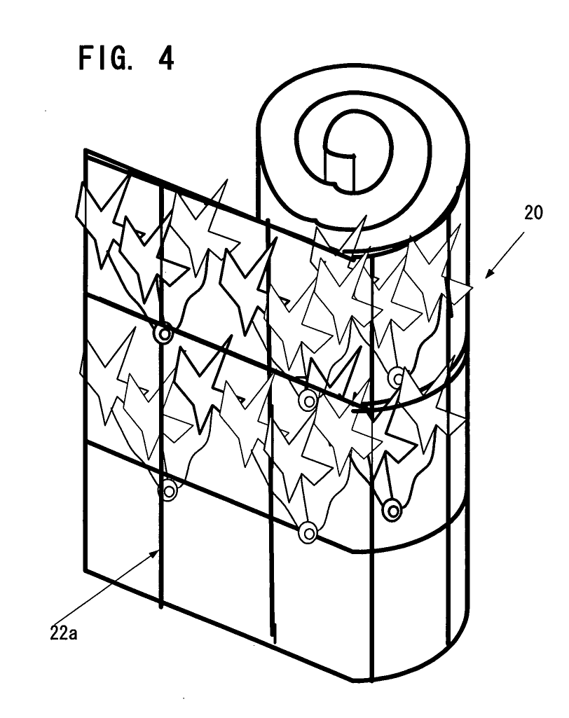

FIG. 4 shows the flexible decorative non-stand-alone structure 20 of the invention in a rolled state in the form of a roll 20a convenient for storage and transportation.

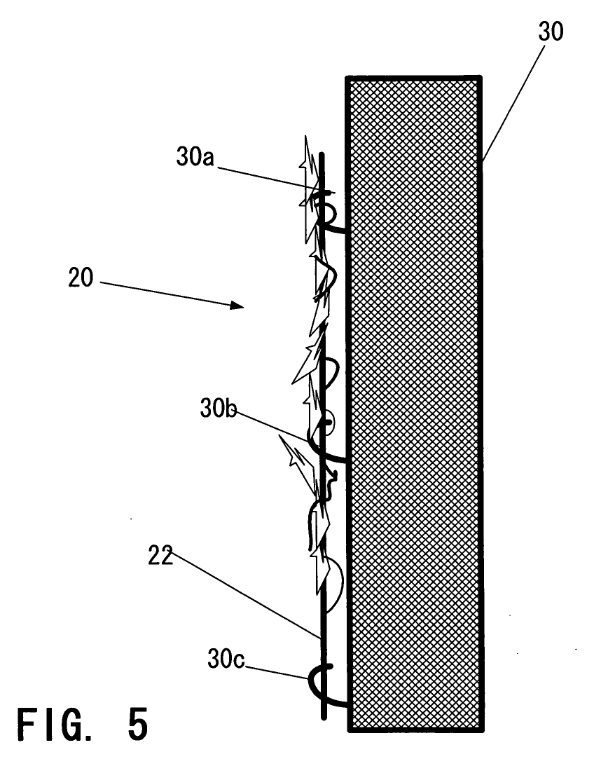

FIG. 5 shows an example of attachment of the flexible decorative structure 20 of the invention to a rigid stand-alone support or substrate, such as, e..g., a wall 30 which may hooks 30a, 30b for hanging the structure 20. It is understood that the hook-type attachment is shown only as an example.

Thus it has been shown that the invention provides a flexible decorative non-stand-alone structure attachable to any substrate such as a wall, fence, etc. The aforementioned structure can be wound into a roll for convenience of storage, transportation, and application. When attached to the fence having openings that expose the view behind the fence, the flexible structure of the aforementioned type can obscure direct view from outsiders. The aforementioned structure may have an attractive appearance imitating a live hedge, vine, flowers, or other foliage. It has a simple construction composed of a molded flexible matrix-type net or mesh and decorative members in the form of leaves, flowers, or the like, easily and reliably connectable to the molded flexible plastic matrix-type net or mesh. If necessary, the flexible decorative elements can be easily replaced entirely or selectively without replacing the matrix-like net or mesh. The decorative structure of the invention can be used indoors as well as outdoors around a year during different climatic seasons.

Although the invention has been shown and described with reference to specific embodiments, it is understood that these embodiments should not be construed as limiting the areas of application of the invention and that any changes and modifications are possible provided that these changes and modifications do not depart from the scope of the attached patent claims. For example, the attachment can be made integrally with the decorative elements, or can be made integrally with the matrix-like infrastructure. Rods that form the supporting frame are not necessarily perpendicular to each other. The decorative elements may be flexible or rigid, if they are small enough and their rigidity does not interfere with rolling of the decorative structure. The flexible cords can be replaced by wires.

What we claim is:

1. A flexible and rollable non-stand-alone decorative structure for attachment to a rigid support comprising:
a matrix-type flexible and rollable infrastructure having a plurality of cells forming through openings;
a plurality of decorative elements having openings; and
thin flexible cord-like connection elements threaded through the openings of the decorative elements and securing the decorative elements to the matrix-type flexible and rollable infrastructure by being twisted around the cells of the matrix-type flexible and rollable infrastructure.

2. The flexible and rollable non-stand-alone decorative structure of claim 1, wherein the aforementioned decorative elements imitate leaves or flowers.

3. The flexible and rollable non-stand-alone decorative structure of claim 1, wherein the matrix-type flexible and rollable infrastructure is molded from plastic as an integral unit.

4. The flexible and rollable non-stand-alone decorative structure of claim 3, wherein the matrix-type flexible and rollable infrastructure comprises extruded rods bonded to the decorative elements.

5. The flexible and rollable non-stand-alone decorative structure of claim 3, wherein the aforementioned decorative elements imitate leaves or flowers.

6. The flexible and rollable non-stand-alone decorative structure of claim 4, wherein the aforementioned decorative elements imitate leaves or flowers.

7. The flexible and rollable non-stand-alone decorative structure of claim 2, wherein the leaves or flowers are grouped with a common connection point having a hole.

8. The flexible and rollable non-stand-alone decorative structure of claim 7, wherein the leaves are made from a rubberized fabric and are formed by stamping from a web.

9. The flexible and rollable non-stand-alone decorative structure of claim 8, wherein the matrix-type flexible and rollable infrastructure is molded from plastic as an integral unit.

10. The flexible and rollable non-stand-alone decorative structure of claim 9, wherein the matrix-type flexible and rollable infrastructure comprises extruded rods bonded to the decorative elements.

11. The flexible and rollable non-stand-alone decorative structure of claim 2, wherein the cord secures the leaves or flowers by being twisted once or more through the cells of the infrastructure.

12. The flexible and rollable non-stand-alone decorative structure of claim 11, wherein the leaves are made from a rubberized fabric and are formed by stamping from a web.

13. The flexible and rollable non-stand-alone decorative structure of claim 12, wherein the matrix-type flexible and rollable infrastructure is molded from plastic as an integral unit.

14. The flexible and rollable non-stand-alone decorative structure of claim 2, wherein the decorative elements are arranged with density that obstructs the view therethrough once the decorative structure has been installed.

15. The flexible and rollable non-stand-alone decorative structure of claim 4, wherein the decorative elements are arranged with density that obstructs the view therethrough once the decorative structure has been installed.
